(19) United States
(12) Patent Application Publication
(10) Pub. No.: US 2016/0048413 A1
(43) Pub. Date: Feb. 18, 2016

(54) PARALLEL COMPUTER SYSTEM, MANAGEMENT APPARATUS, AND CONTROL METHOD FOR PARALLEL COMPUTER SYSTEM

(71) Applicant: FUJITSU LIMITED, Kawasaki-shi (JP)

(72) Inventors: Kazuhiro Matsuyama, Numazu (JP); Tsuyoshi HASHIMOTO, Kawasaki (JP)

(21) Appl. No.: 14/794,858

(22) Filed: Jul. 9, 2015

(30) Foreign Application Priority Data
Aug. 18, 2014 (JP) 2014-165903

(51) Int. Cl. G06F 9/50

(52) U.S. Cl. CPC G06F 9/5005

(57) ABSTRACT

The parallel computer system includes a plurality of information processing apparatuses and a management apparatus to control the information processing apparatuses. Each of the plurality of information processing apparatuses outputs a resource usage quantity variation with respect to a job at a predetermined time interval. The management apparatus generates an execution history containing an attribute of the job and the resource usage quantity variation every time the job is executed, estimates a resource usage quantity of a new job, based on resource usage quantity variations contained in an execution history of a reference job matching the new job in terms of the attribute within a predetermined degree, and specifies the information processing apparatus to be assigned the new job, based on the estimated resource usage quantity.

### CROSS-REFERENCE TO RELATED APPLICATION

This application is based upon and claims the benefit of priority of the prior Japanese Patent Application No. 2014-165903, filed on Aug. 18, 2014, the entire contents of which are incorporated herein by reference.

### FIELD

The embodiments discussed herein are related to a parallel computer system, a management apparatus, and a control method for the parallel computer system.

### BACKGROUND

The parallel computer system improves processing performance of a whole system by allocating processes (which will hereinafter be referred to also as jobs) in distribution to a plurality of processors and executing the jobs assigned to the plurality of processors in parallel. The jobs, which are executed by the parallel computer system, are assigned to the respective processors while adjusting an execution schedule to distribute loads. “Scheduling” based on execution histories of the jobs is one of methods of adjusting the execution schedule of the jobs.

The scheduling based on the execution histories of the jobs is that the jobs similar to a newly inputted job are detected from the execution histories. The execution history contains execution condition instanced by usage time of a processor, a usage quantity of a memory, a number of nodes to be used and other equivalent elements. The execution condition of the new job to be newly inputted is predicted based on the execution histories of the similar jobs detected, and the execution schedule of the job is adjusted to distribute loads.

### Patent Document

[Patent document 1] Japanese Laid-Open Patent Publication No. H05-313921
[Patent document 2] Japanese Laid-Open Patent Publication No. 2005-148901
[Patent document 3] Japanese Laid-Open Patent Publication No. H08-152903
[Patent document 4] International Publication Pamphlet No. WO 2011/102219
[Patent document 5] Japanese National Publication of International Patent Application No. 2007-519103

### SUMMARY

One of aspects of embodiments of the disclosure is exemplified by a parallel computer system. The parallel computer system includes a plurality of information processing apparatuses and a management apparatus to control the plurality of information processing apparatuses. Each of the plurality of information processing apparatuses includes a processor, and a memory storing instructions, the instructions causing the processor to perform outputting a resource usage quantity variation per resource of a self-apparatus with respect to a job to be executed by the self-apparatus at a predetermined time interval. The management apparatus includes a processor, and a memory storing instructions, the instructions causing the processor to perform generating an execution history containing an attribute of the execution target job and the resource usage quantity variation being output by the processor of each information processing apparatus every time the job is executed, estimating a resource usage quantity of a new job being newly inputted, based on resource usage quantity variations contained in an execution history of a reference job matching the new job in terms of the attribute within a predetermined degree, and specifying the information processing apparatus to be assigned the new job, based on the estimated resource usage quantity.

The object and advantages of the invention will be realized and attained by means of the elements and combinations particularly pointed out in the claims. It is to be understood that both the foregoing general description and the following detailed description are exemplary and explanatory and are not restrictive of the invention.

### BRIEF DESCRIPTION OF THE DRAWINGS

FIG. 1 is a diagram illustrating one example of system architecture of a parallel computer system;

FIG. 2 is a diagram illustrating one example of processing configurations of respective nodes and a server in the parallel computer system;

FIG. 3 is a diagram illustrating one example of a data structure of a resource usage variation;

FIG. 4 is a diagram illustrating one example of a data structure of an execution history;

FIG. 5A is a diagram illustrating one example of a data structure of an input parameter;

FIG. 5B is a diagram illustrating one example of a data structure of a program record;

FIG. 5C is a diagram illustrating one example of a data structure of a user record;

FIG. 5D is a diagram illustrating one example of a data structure of a job resource designation record;

FIG. 6 is a diagram illustrating one example of a data structure of an appropriative resource record;

FIG. 7 is a diagram illustrating one example of a data structure of a resource usage variation record.

FIG. 8 is a diagram of one example of a flowchart of a process of recording the variation of the resource usage quantity;

FIG. 9 is a diagram of one example of a flowchart of a process of registering the execution history after finishing executing the job;

FIG. 10 is a diagram of one example of a flowchart of a cluster analysis process of the execution history;

FIG. 11 is a diagram of one example of a flowchart of a process of obtaining a degree of non-similarity between the clusters;

FIG. 12 is a diagram of one example of a flowchart of a process of obtaining an estimated value of a resource usage quantity of a new job; and

FIG. 13 is a diagram of one example of a flowchart of a process of optimizing an allocation position of a resource used for the new job.

### DESCRIPTION OF EMBODIMENTS

The scheduling based on the execution histories of the jobs does not obtain the proper execution conditions of the similar jobs as the case may be. For example, the same parallel program is not necessarily executed to the same degree of parallelism each time. In other words, such a case may occur that a plurality of jobs to execute the same program does not have the same execution condition. This being the case, the proper execution conditions of the similar jobs are not acquired.

Further, means for parallelizing processors has been diversified in recent years. Accelerators instanced by General-Purpose computing on Graphics Processing Units (GPGPU) or Field Programmable Gate Array (FPGA) and other equivalent accelerator are equipped in apart of nodes within the parallel computer system as the case may be.

Heterogeneous system architecture, including heterogeneous processors existing in mixture as instanced by mounting the accelerators in a part of nodes, may have a case of the execution condition being different even when a job name, a usage node count and other equivalent information are the same. Hereat, the proper execution conditions of the similar jobs are not acquired.

Furthermore, the parallel computer system comes to have the heterogeneous system architecture by upgrading Central Processing Units (CPUs) of a part of nodes and adding a node group mounted with next-generation CPUs. Hereat, the proper execution conditions, taking account of a difference of environment, of the similar jobs are not acquired.

The proper execution conditions of the similar jobs not being acquired, it is unfeasible to presume an execution condition of a new job, thereby disabling the scheduling from equalizing the loads on the plurality of information processing apparatuses that execute the jobs.

Embodiments of the present invention will hereinafter be described based on the drawings. Configurations of the following embodiments are exemplifications, and the present invention is not limited to the configurations of the embodiments.

### First Embodiment

A first embodiment is that a parallel computer system records a variation of a resource usage quantity of a job to be executed per unit time, and generates an execution history. The parallel computer system estimates the resource usage quantity of a newly inputted job (which will hereinafter be also termed a new job) on the basis of execution histories of existing jobs (which will hereinafter be also referred to as similar jobs or reference jobs) having a predetermined similarity to the new job, i.e., matching the new job in terms of the attribute within a predetermined degree.

The job execution histories may be classified into a plurality of clusters by a cluster analysis. In this case, a resource usage quantity of each cluster can be estimated based on intra-cluster execution histories by, e.g., a regression analysis. The resource usage quantity of the new job may be estimated based on the resource usage quantity of the cluster including the similar jobs.

<System Architecture>

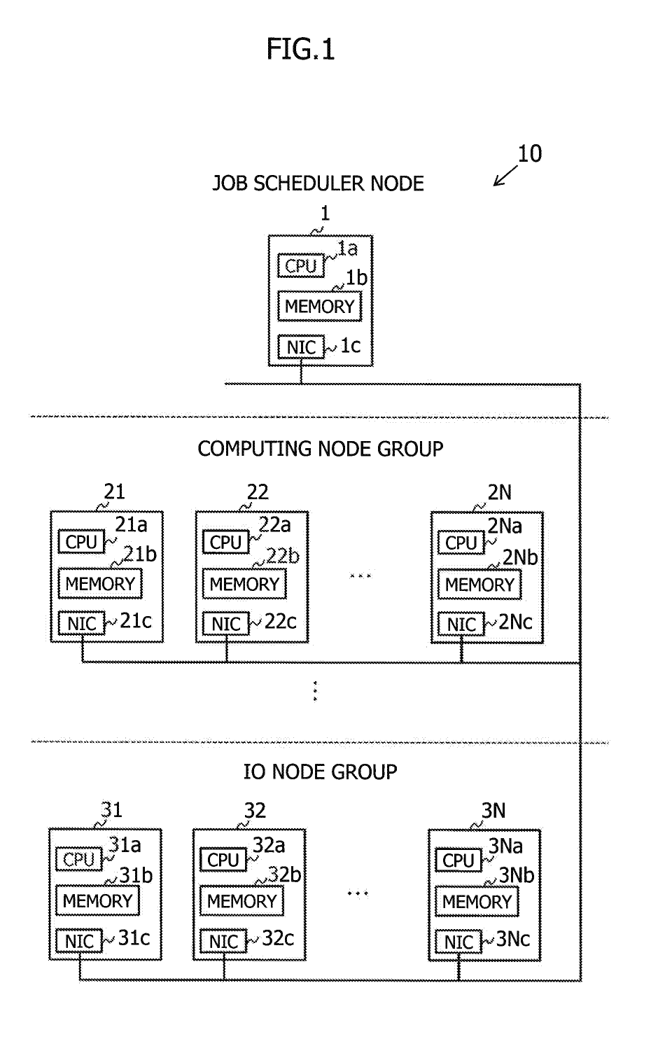

FIG. 1 is a diagram illustrating one example of system architecture of a parallel computer system 10. The parallel computer system 10 includes: a job scheduler node 1; a computing node group exemplified by computing nodes 21-2N; and an IO node group exemplified by Input/Output (IO) nodes 31-3N, the respective nodes being interconnected. Note that a network topology may be, without being limited to the topology in FIG. 1, an N-dimensional mesh topology, an N-dimensional torus topology, a Fat Tree topology and a combination of these topologies.

The parallel computer system 10 does not restrict a number of computing nodes and a number of IO nodes. The parallel computer system 10 includes the interconnected computing nodes that are generically termed computing nodes 2. Further, the parallel computer system 10 includes the interconnected IO nodes that are generically termed IO nodes 3.

The job scheduler node 1 manages a resource usage state of the job and allocates resources to the respective jobs. The job scheduler node 1 in FIG. 1 includes a Central Processing Unit (CPU) 1a, a memory 1b and a network Interface Card (NIC) 1c. Note that a specific apparatus configuration of the job scheduler node 1 may be properly modified as instanced by addition, replacement, deletion and other equivalent modifications without being limited to the configuration illustrated in FIG. 1.

The CPU 1a carries out a variety of processes by executing a computer program deployed in an executable manner on the memory 1b. CPUs 1a may be provided as a plurality of CPUs without being limited to the single CPU.

The memory 1b provides a storage area used for the CPU 1a to load the program and an operation area used for the CPU 1a to execute the program. The memory 1b is employed as a buffer for temporarily retaining data. Further, the memory 1b stores the variety of programs and the data used by the CPU 1a to execute these programs. The memory 1b is a semiconductor memory exemplified by a volatile Random Access Memory (RAM), a nonvolatile Read Only Memory (ROM) and other equivalent memories.

The NIC 1c is an interface for inputting and outputting information to or from a network. The NIC 1c connects to a cable network or a wireless network. The data and other equivalent elements received via the NIC 1c are stored in the memory 1b.

The computing node 2 executes the job allocated by the job scheduler node 1, and records a variation quantity of the resource usage quantity used by executing the job as a resource usage variation per unit time. The resource usage variation is recorded and managed on a resource-by-resource basis. The resources are instanced by CPU time, a working set size, a virtual space size, a memory access quantity (i.e., a cache miss occurrence quantity) per unit time, an Input/Output Per Second (IOPS) and an IO bandwidth. Further, when the CPU 2a of the computing node 2 is classified as a multiprocessor including a plurality of processor cores and other equivalent processors, the resource usage variation is recorded on a core-by-core basis.

The computing node 2 includes a CPU 21a, a memory 21b and a NIC 21c in FIG. 1. A computing node 22 includes a CPU 22a, a memory 22b and a NIC 22c. A computing node 2N includes a CPU 2Na, a memory 2Nb and a NIC 2Nc. Note that a specific apparatus configuration of the computing node 2 may be properly modified as instanced by addition, replacement, deletion and other equivalent modifications without being limited to the configuration illustrated in FIG. 1.

The respective computing nodes 2 include the CPUs 21a-2Na that are generically termed CPUs 2a. The computing nodes 2 include the memories 21b-2Nb that are generically termed memories 2b. The computing nodes 2 include the NICs 21c-2Nc that are generically termed NICs 2c. Each computing node 2 includes, similarly to the computing node 21, the CPU 2a, the memory 2b and the NIC 2c.

The CPU 2a carries out a variety of processes by executing a computer program deployed in the executable manner on the memory 2b. CPUs 2a may be provided as a plurality of CPUs without being limited to the single CPU. Further, the CPU 2a may be a multicore processor mounted with a plurality of processor cores. Moreover, the CPU 2a may be configured as an accelerator instanced by a GPGPU, a FPGA and other equivalent accelerators. The accelerator may be configured to include a plurality of processor cores. When the CPU 2a is the multicore processor, the processor cores included in the CPU 2a will hereinafter be also simply referred to as cores.

The memory 2b provides a storage area used for the CPU 2a to load the program and an operation area used for the CPU 2a to execute the program. The memory 2b is employed as a buffer for temporarily retaining the data. Further, the memory 2b stores the variety of programs and the data used by the CPU 2a to execute these programs. The memory 2b is the semiconductor memory exemplified by the volatile RAM, the nonvolatile ROM and other equivalent memories.

The NIC 2c is the interface for inputting and outputting the information to or from the network. The NIC 2c connects to the cable network or the wireless network. The data and other equivalent elements recorded in the memory 2b are transmitted to the network via the NIC 2c.

The IO node 3 retains the data used for executing the job. The computing node 2 uses the network resources to access the IO node 3 via the network when executing the job. The IO node 31 includes a CPU 31a, a memory 31b and a NIC 31c in FIG. 1. The IO node 32 includes a CPU 32a, a memory 32b and a NIC 32c. The IO node 3N includes a CPU 3Na, a memory 3Nb and a NIC 3Nc. Note that a specific apparatus configuration of the IO node 3 may be properly modified as instanced by addition, replacement, deletion and other equivalent modifications without being limited to the configuration illustrated in FIG. 1.

The respective IO nodes include the CPUs that are generically termed CPUs 3a. The respective IO nodes include the memories that are generically termed memory 3b. The respective IO nodes include the NICs that are generically termed NICs 3c. Each IO node 3 includes, similarly to the IO node 31, the CPU 3a, the memory 3b and the NIC 3c.

The CPU 3a carries out a variety of processes by executing a computer program deployed in the executable manner on the memory 3b. CPUs 3a may be provided as a plurality of CPUs without being limited to the single CPU.

The memory 3b provides a storage area used for the CPU 3a to load the program and an operation area used for the CPU 3a to execute the program. The memory 3b is employed as the buffer for temporarily retaining the data. Further, the memory 3b stores the variety of programs and the data used by the CPU 3a to execute these programs. The memory 3b is the semiconductor memory exemplified by the volatile RAM, the nonvolatile ROM and other equivalent memories. The memory 3b stores the data used for executing, e.g., the job.

The NIC 3c is the interface for inputting and outputting the information to or from the network. The NIC 3c connects to the cable network or the wireless network. The data and other equivalent elements recorded in the memory 3b are transmitted to the computing node 2 via the NIC 3c and used for executing the job.

<Processing Configuration>

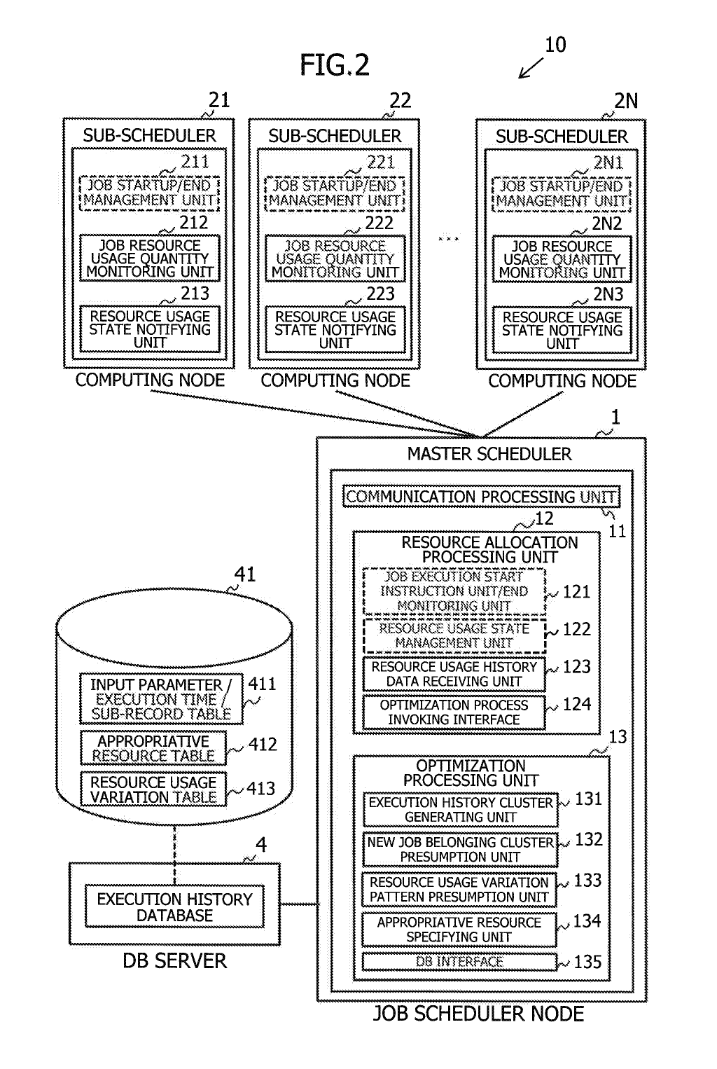

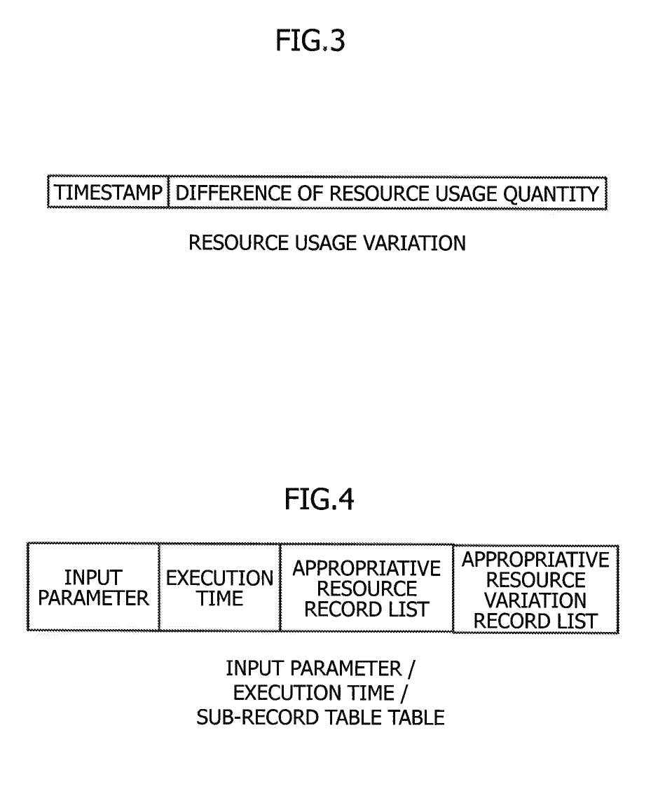

FIG. 2 illustrates an example of processing configurations of the parallel computer system 10, and FIGS. 3 through 7 depict examples of data structures of the data used in respective processing configurations.

FIG. 2 is a diagram illustrating one example of the processing configurations of the respective nodes and a server of the parallel computer system 10. The parallel computer system 10 includes the job scheduler node 1, the computing nodes 2 (21 through 2N) and a database (DB) server 4 in FIG. 2.

The job scheduler node 1 serving as a master scheduler adjusts a job execution schedule. The job scheduler node 1 includes a communication processing unit 11, a resource allocation processing unit 12 and an optimization processing unit 13. The CPU 1a executes processes of the respective processing configurations held by the job scheduler node 1 in accordance with the computer program. A hardware circuit may execute any one of the processing configurations held by the job scheduler node 1 or a part of the processes thereof.

The communication processing unit 11 controls a process of communications with the computing node 2. The resource allocation processing unit 12 receives the data from the computing node 2 via the communication processing unit 11 and instructs the computing node 2 to execute the job. The communication processing unit 11 and the resource allocation processing unit 12 are one example of a control unit.

The resource allocation processing unit 12 manages the resource usage state, allocates the resources to the job and instructs the computing node 2 to start executing the job. The resource allocation processing unit 12 includes a job execution start instruction unit/end monitoring unit 121, a resource usage state management unit 122, a resource usage history data receiving unit 123 and an optimization process invoking interface 124.

The job execution start instruction unit/end monitoring unit 121 instructs the computing node 2 receiving assignment of the job to start executing the job. Further, the job execution start instruction unit/end monitoring unit 121 monitors the execution of the job, and detects an end of the job.

The resource usage state management unit 122 manages a usage state of each resource of the computing node 2, and notifies the optimization processing unit 13 of candidates for an allocation position of the computing node 2 that is allocated to the job (the candidates being also hereinafter referred to as allocation position candidates) corresponding to the resource usage state. Herein, the “allocation position” connotes one computing node 2 allocated to the job or a combination of plural computing nodes 2 allocated thereto in the parallel computer system 10.

The resource usage history data receiving unit 123 receives, from the computing node 2 via the communication processing unit 11, resource usage variation data with the resource usage variation quantity being recorded per resource used for executing the job. The resource usage history data receiving unit 123 can receive the resource usage variation data, e.g., when finishing the job detected by the job execution start instruction unit/end monitoring unit 121.

Moreover, the resource usage history data receiving unit 123 generates an execution history per job from the received resource usage variation data. The generated execution history is recorded in the DB server 4. The resource usage history data receiving unit 123 is one example of a generation unit.

The optimization process invoking interface 124 is an interface for invoking a process to be executed by the optimization processing unit 13. The process to be executed by the optimization processing unit 13 contains a process for estimating the variation quantity of the resource usage of the new job from the execution history.

The optimization processing unit 13 classifies the execution histories into a plurality of groups, and optimizes the allocation position of the new job by estimating the resource usage variation of the new job from the execution history contained in the group to which the new job belongs. The optimization processing unit 13 includes an execution history cluster generating unit 131, a new job belonging cluster presumption unit 132, a resource usage variation pattern presumption unit 133, an appropriative resource specifying unit 134 and a DB interface 135.

The execution history cluster generating unit 131 classifies the execution histories into the plurality of groups. For instance, the execution history cluster generating unit 131 generates a “Hierarchized Cluster” configuring a “Tree” being integrally hierarchized up to one “Highest-Order” cluster by a nearest neighbor method, a median method and other equivalent clustering methods, thereby enabling the execution histories to be classified into the plurality of clusters. Each cluster contains one or more execution histories. The execution histories contained in the same cluster mutually have a predetermined degree of similarity. The execution history cluster generating unit 131 is one example of a classifying unit.

The new job belonging cluster presumption unit 132 presumes which cluster in the clusters generated by the execution history cluster generating unit 131 the new job belongs to. The new job belonging cluster presumption unit 132 presumes a cluster containing the execution history of the similar job having similarities of job attributes as the cluster to which the new job belongs. The job attributes are instanced by a program name, a load module to be used, a binary hash value of a library function, a user, a group to which the user belongs and execution scheduled time.

The resource usage variation pattern presumption unit 133 presumes, based on the execution history of the similar job contained in the cluster to which the new job belongs, a resource usage variation pattern of the new job. The resource usage variation pattern is specifically exemplified by a frequency component of the resource usage variation. The resource usage variation pattern presumption unit 133 can presume the resource usage variation pattern of the new job by the regression analysis of the intra-cluster execution history. When the execution histories of the similar jobs are contained in the plurality of clusters, the resource usage variation pattern presumption unit 133 may presume the resource usage variation pattern of the new job by taking account of a belonging probability corresponding to the number of execution histories, contained in the respective clusters, of the similar jobs. The resource usage variation pattern presumption unit 133 is one example of a presumption unit.

The appropriative resource specifying unit 134 specifies the resources to which the new job is allocated, based on the presumed resource usage variation pattern of the new job. The DB interface 135 is an interface with the DB server 4. The optimization processing unit 13 acquires, from the DB server 4, the data used for presuming the resource usage variation pattern of the new job via the DB interface 135. The appropriative resource specifying unit 134 is one example of a specifying unit.

The computing node 2 serving as a sub-scheduler executes the job assigned by the job scheduler node 1, and records the resource usage variation of each computing node 2 per predetermined unit time. The computing node 2 records the resource usage variation of the self computing node 2 at an interval of time, e.g., 1 sec. When the CPU 2a is the multicore processor and other equivalent processors, the resource usage variation is recorded on the core-by-core basis.

The computing node 21 includes a job startup/end management unit 211, a job resource usage quantity monitoring unit 212 and a resource usage state notifying unit 213 in FIG. 2. The computing node 22 includes a job startup/end management unit 221, a job resource usage quantity monitoring unit 222 and a resource usage state notifying unit 223. The computing node 2N includes a job startup/end management unit 2N1, a job resource usage quantity monitoring unit 2N2 and a resource usage state notifying unit 2N3.

Each computing node 2 includes the job startup/end management units 211-2N1 that are generically termed job startup/end management units 21. Each computing node 2 includes the job resource usage quantity monitoring units 212-2N2 that are generically termed job resource usage quantity monitoring units 22. Each computing node 2 includes the resource usage state notifying units 213-2N3 that are generically termed resource usage state notifying units 23. Similarly to the computing node 21, each computing node 2 includes the job startup/end management unit 21, the job resource usage quantity monitoring unit 22 and the resource usage state notifying unit 23.

The CPU 2a executes processes of the respective processing configurations held by the computing node 2 in accordance with the computer program. A hardware circuit may execute any one of the processing configurations held by the computing node 2 or a part of the processes thereof.

The job startup/end management unit 21 starts up the job upon receiving an instruction from the job execution start instruction unit/end monitoring unit 121. Further, the job startup/end management unit 21 notifies the job execution start instruction unit/end monitoring unit 121 of an end of the job.

The job resource usage quantity monitoring unit 22 monitors the resource usage quantity of the job and, with an elapse of time of each job, records the resource usage variation of each node per predetermined unit time. The resource usage variation may be recorded per resource. The job resource usage quantity monitoring unit 22 can store the resource usage variation as a resource usage history in the memory 2b. The job resource usage quantity monitoring unit 22 is one example of an output unit. The resource usage state notifying unit 23 notifies the resource usage history data receiving unit 123 of the resource usage variation data recorded by the job resource usage quantity monitoring unit 22.

The DB server 4 stores the job execution history generated by the resource usage history data receiving unit 123. The DB server 4 includes an execution history database 41. The execution history database 41 includes an input parameter/execution time/sub-record table 411, and appropriative resource table 412 and a resource usage variation table 413.

The input parameter/execution time/sub-record table 411 is a main table in which the job execution histories are stored. The appropriative resource table 412 is a table in which appropriative resources used for executing the job are stored. The appropriative resources are devices used for the jobs, the resources being instanced by the CPU 2a, the cores of the CPU 2a and the memory 2b, specified areas within the memory, and other equivalent elements.

The resource usage variation table 413 is configured to decompose the resource usage variation per resource into frequency components on each computing node 2 or each core and to store the resource usage variation per frequency component. The resource usage variation is decomposed into the frequency components through, e.g., discrete Fourier transform (DFT). Herein, the discrete Fourier transform includes discrete cosine transform and discrete sine transform in a broad sense.

FIG. 3 is a diagram illustrating one example of a data structure of the resource usage history. The resource usage history is the resource usage variation recorded by the job resource usage quantity monitoring unit 22 of the computing node 2. The resource usage history stores a “timestamp” and a “difference of resource usage quantity” in FIG. 3. The “timestamp” is time for recording the difference of the resource usage quantity. The “difference of resource usage quantity” is a variation quantity of the resource usage quantity from the last timestamp to the present timestamp. The resource usage history is to be recorded per resource in the example of FIG. 3.

FIG. 4 is a diagram illustrating one example of a data structure of the execution history. The execution histories are stored as the input parameter/execution time/sub-record table 411 in the execution history database 41. The input parameter/execution time/sub-record table 411 stores an “input parameter”, “execution time”, an “appropriative resource record list” and an “appropriative resource variation record list”. The “input parameter” is data of a parameter designated before executing the job. The “execution time”, the “appropriative resource record list” and the “appropriative resource variation record list” are data to be registered as results of the execution after executing the job.

The “input parameter” contains data indicative of management target properties related to Operating System (OS), the job scheduler or a runtime system of a language processing system. The “input parameter” contains items of data instanced by a program name, a binary hash value of the program, a binary hash value of a load module to be used, a binary hash value of the library function to be used, the user, the group to which the user belongs, the execution scheduled time and other equivalent data. The binary hash values of the load module to be used and of the library function to be used may be acquired from the job program. Further, when designating a condition pertaining to the computing node 2 or the core used for executing the job, the “input parameter” contains conditions designating a usage node count, a usage core count, an arrangement of the usage nodes and other equivalent attributes. The input parameter is one example of an attribute.

The “execution time” stores time expended for executing the job. The “appropriative resource record list” is a list containing a predetermined number of appropriative resource records managed in the appropriative resource table 412. The “appropriative resource variation record list” is a list containing a predetermined number of appropriative resource variation records managed in the resource usage variation table 413.

Moreover, the execution history may be considered to be elements of a direct product set “CP×TR” determined from two sets CP and TR given as below.

CP=[(Combination of) Input Parameters: I]

TR=[Data Sampled upon Execution (Execution time, Appropriative Resource, Resource Usage Variation): D]

(I,D)εCP×TR

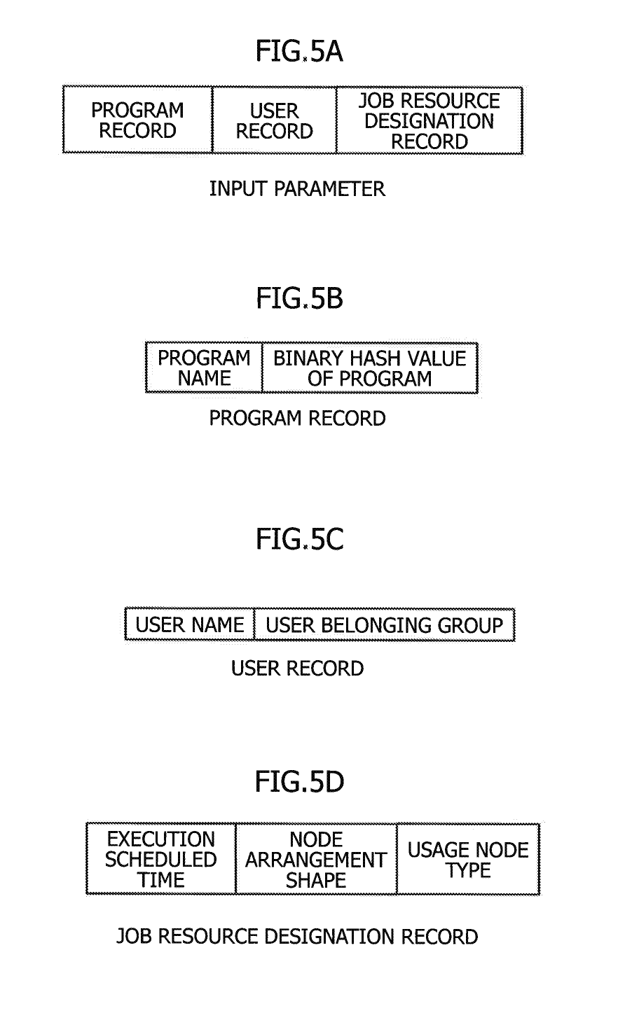

FIGS. 5A, 5B, 5C and 5D are diagrams illustrating the input parameters. FIG. 5A is the diagram illustrating one example of a data structure of the input parameter. The input parameter contains a “program record”, a “user record” and a “job resource designation record”. FIGS. 5B, 5C and 5D illustrate data structures of the “program record”, the “user record” and the “job resource designation record”, respectively.

FIG. 5B is the diagram illustrating one example of the data structure of the program record. The program record contains a “program name” and a “binary hash value of program”. The “program name” stores a program name of the job. The “binary hash value of program” stores a binary hash value of the program concerned.

FIG. 5C is the diagram illustrating one example of the data structure of the user record. The user record contains a “user name” and a “belonging group of user”. The “user name” stores a user of the job. The “belonging group of user” stores a group to which the user belongs.

FIG. 5D is the diagram illustrating one example of a data structure of the job resource designation record. The job resource designation record contains “execution scheduled time”, a “node arrangement shape” and a “usage node type”. The “execution scheduled time” stores execution time to be predicted. The “node arrangement shape” stores a combination of one or more computing nodes 2 used for executing the job. The “usage node type” stores a type of the computing node 2 used for executing the job. The type of the computing node 2 is designated based on specifications of the resources contained in the computing node 2, the specifications being exemplified by performance of the CPU 2a, a capacity of the memory 2b or by information about whether the CPU 2a is the accelerator like the GPGPU, the FPGA and other equivalent accelerators.

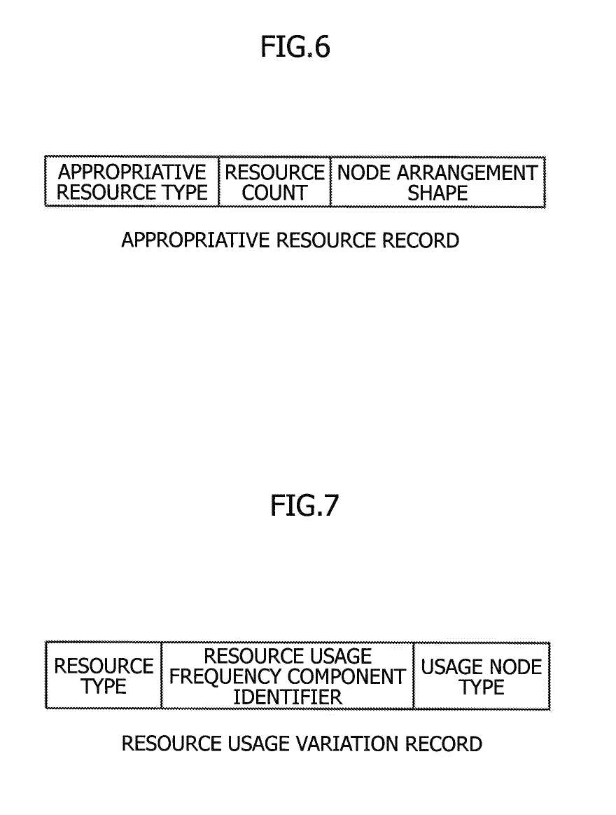

FIG. 6 is a diagram illustrating one example of a data structure of the appropriative resource record. The appropriative resource record contains an “appropriative resource type”, a “resource count” and a “node arrangement shape”. The “appropriative resource type” stores an appropriative resource type like the CPU 2a, the core of the CPU 2a, the memory 2b, the specified area in the memory and other equivalent components. The “resource count” stores the number of the appropriative resources used for executing the job. The “node arrangement shape” stores a combination of one or more computing nodes 2 used for executing the job.

FIG. 7 is a diagram illustrating one example of a data structure of the resource usage variation record. The resource usage variation record contains a “resource type”, a “resource usage frequency component identifier” and a “usage node type”. The “resource type” is a type of the resource used by each computing node 2 or each core. The resource is exemplified by CPU time, a working set size, a virtual space size, a memory access quantity (i.e., a cache miss occurrence quantity) per unit time, an IOPS and an IO bandwidth. The “resource usage frequency component identifier” stores an identifier for specifying the frequency component into which to decompose the usage quantity variation of the resource of each computing node 2 or each core. The resource usage frequency component is, after an end of executing the job, recorded on an auxiliary storage device (unillustrated) within the DB server 4 and acquired with the “resource usage frequency component identifier”. The “usage node type” stores a type of the computing node 2 used for executing the job.

<Processing Flow>

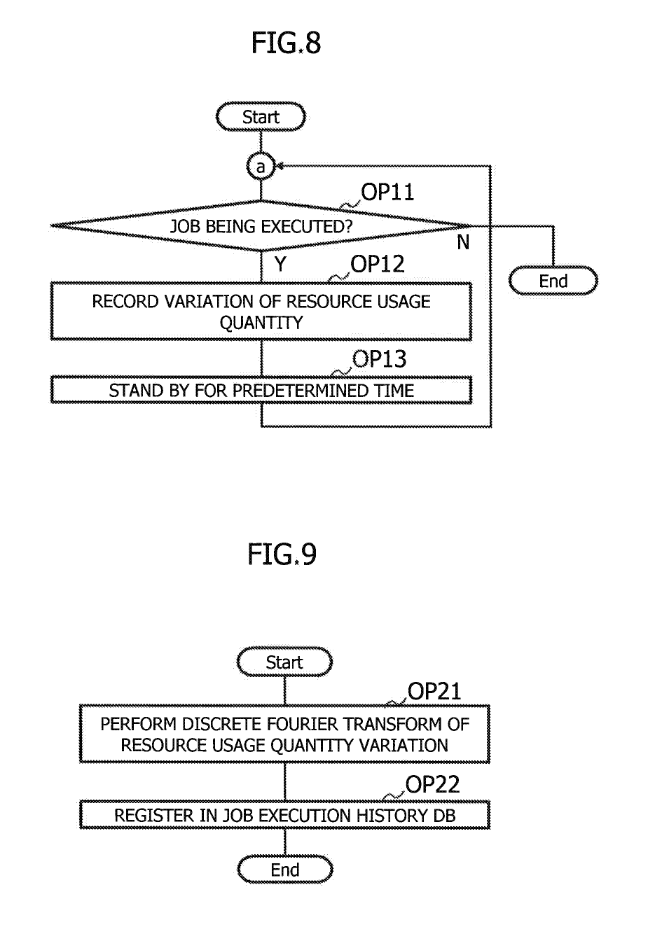

FIGS. 8 through 12 are explanatory diagrams of processing flows in a first embodiment. FIG. 8 is one example of a flowchart of a process of recording the variation of the resource usage quantity. A start of the processes illustrated in FIG. 8 is triggered by an event that the job startup/end management unit 21 of the computing node 2 starts up the job.

In OP11, the job resource usage quantity monitoring unit 22 determines whether the job is executed underway on the computing node 2 or not. When the job is executed underway (OP11: Y), the processing advances to OP12. Whereas when the job is not executed underway (OP11: N), the process illustrated in FIG. 8 is ended.

In OP12, the job resource usage quantity monitoring unit 22 records the resource usage variation quantity on the computing node 2 in the memory 2b per resource. Each resource usage variation quantity is recorded in a form of, e.g., the data structure of the resource usage variation depicted in FIG. 3. Next, the processing advances to OP13.

In OP13, the job resource usage quantity monitoring unit 22 stands by for a predetermined period of time. The processing subsequently loops back to “a”, and the processes in OP11 through OP13 are repeated during the execution of the job (OP11: Y). Given herein is an example of recording the resource usage variation per computing node 2, however, the job resource usage quantity monitoring unit 22 records the resource usage variation on the core-by-core basis when the CPU 2a includes the plurality of processor cores as in the case of the multicore processor and other equivalent processors.

FIG. 9 is one example of a flowchart of processes of registering the execution history after finishing executing the job. The processes of registering the execution history are started after recording the resource usage variation on each computing node 2 through the processes illustrated in FIG. 8 and finishing the execution of the job. The start of the processes illustrated in FIG. 9 is triggered, e.g., by an event that the job execution start instruction unit/end monitoring unit 121 receives notification indicating an end of the job on each computing node 2 from the computing node 2 executing the job.

In OP21, the resource usage history data receiving unit 123 receives the resource usage variation data from the computing node 2 executing the job, and extracts the frequency component from the variation of the resource usage quantity by the discrete Fourier transform. Next, the processing advances to OP22.

In OP22, the resource usage history data receiving unit 123 generates the job execution history containing the extracted frequency component, and registers the generated execution history in the execution history database 41. The job execution history is recorded in the form of, e.g., the data structure of the execution history illustrated in FIG. 4. The processes depicted in FIG. 9 are thereafter finished.

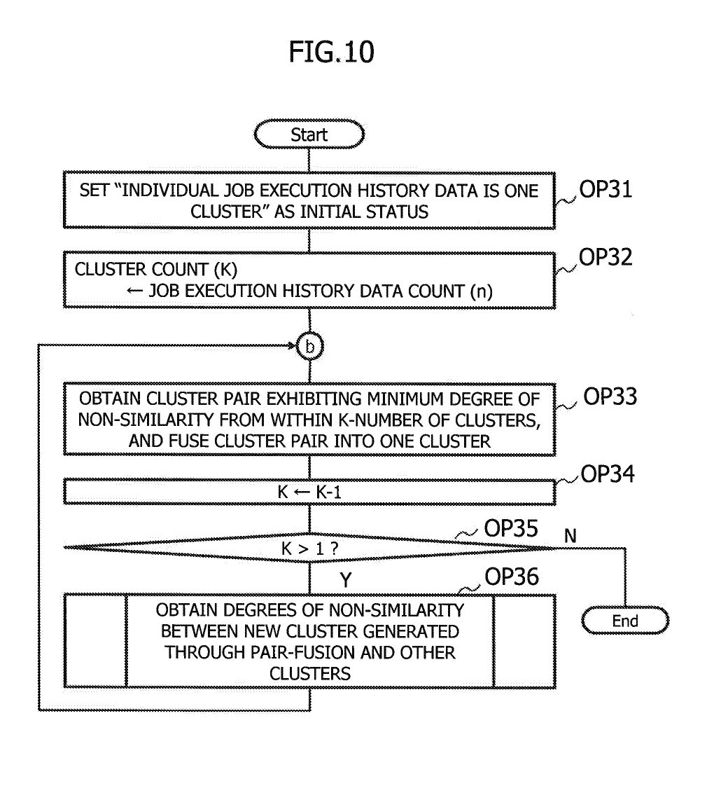

FIG. 10 is one example of a flowchart of a cluster analysis process of the execution history. The process illustrated in FIG. 10 is the cluster analysis process for the job execution history generated by the process illustrated in FIG. 9. The cluster analysis process in FIG. 10 is to generate the “Hierarchized Cluster” configuring the “Tree” being integrally hierarchized up to one “Highest-Order” cluster. The execution history cluster generating unit 131 starts and dynamically executes the cluster analysis process at predetermined timing.

In OP31, the execution history cluster generating unit 131 sets an individual job execution history data as one cluster as an initial status. Next, the processing advances to OP32. In OP32, the execution history cluster generating unit 131 sets job execution history data count “n” to a cluster count “K”. Note that the processes in OP31 and OP32 may be replaced in sequence. Next, the processing advances to OP33.

In OP33, the execution history cluster generating unit 131 obtains a pair of clusters exhibiting a minimum degree of non-similarity from within a K-number of clusters, and fuses the pair of clusters into one cluster. The degree of non-similarity is equivalent to a distance between one execution history and another execution history or between one cluster and another cluster containing execution histories.

The distance in the first embodiment may a Euclidean distance with respect to numeric values as instanced by an interval scale of job start date/time and other equivalent information or instanced by a ratio scale of the resource usage quantity and other equivalent information. The distance may further be binary data of “0” and “1” indicative of whether coincident or not with respect to a nominal scale of a qualitative user name and other equivalent information.

When using a plurality of scales instanced by the nominal scale, the interval scale and the ratio scale on the occasion of making a comparison, a value obtained by multiplying the respective scales by a predetermined weight coefficient in consideration of weighting of each scale and adding multiplied results, may be determined as the distance, i.e., the degree of non-similarity. The processing advances to OP34 next to OP33.

In OP34, the execution history cluster generating unit 131 substitutes “K−1” into “K” and decrements the cluster count “K” by “1”. Next, the processing advances to OP35. It is determined in OP35 whether “K” is larger than “1” or not. When “K” is larger than “1” (OP35: Y), the processing advances to OP36. Whereas when “K” is equal to or smaller than “1” (OP35: N), the processing illustrated in FIG. 9 is ended.

In OP36, the execution history cluster generating unit 131 obtains a degree of non-similarity between the new cluster generated the pair fusion in OP33 and each of other clusters. Next, the processing loops back to “b”, and the processes in OP33 through OP36 are iterated when “K” is larger than “1” (OP35: Y), i.e., till completion of generating the hierarchized cluster.

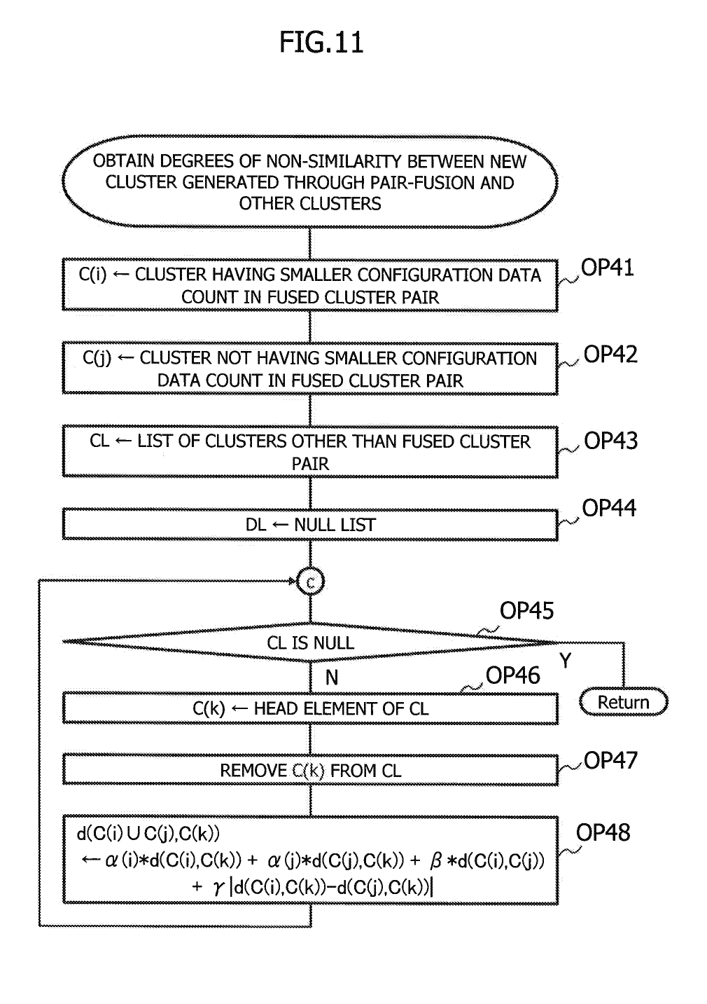

FIG. 11 is one example of a flowchart of a process of obtaining the degree of non-similarity between the clusters. FIG. 11 illustrates details of the process in OP36 of FIG. 10. Note that processes in OP41 through OP44 may be carried out in arbitrary sequence.

In OP41, the execution history cluster generating unit 131 sets, in C(i), the cluster composed of a smaller count of execution history data in the cluster pair fused in OP33. In OP42, the execution history cluster generating unit 131 sets, in C(j), the cluster composed of not smaller count of execution history data in the cluster pair fused in OP33. When both of the fused cluster pair have the same count of data, it may be sufficient that one cluster is set in C(i), while the other cluster is set in C(j).

In OP43, the execution history cluster generating unit 131 sets, in CL, a list of clusters other than the fused cluster pair, i.e., the clusters C(i) and C(j). In OP44, the execution history cluster generating unit 131 sets a null list in DL. Next, the processing advances to OP45.

In OP45, the execution history cluster generating unit 131 determines whether CL is the null list or not. When CL is the null list (OP45: Y), the processes illustrated in FIG. 11 are finished, and the processing loops back to “b” in FIG. 10. Whereas when CL is not the null list (OP45: N), the processing advances to OP46.

In OP46, the execution history cluster generating unit 131 sets, in C(k), the cluster of a head element of CL. Next, the processing advances to OP47. In OP47, the execution history cluster generating unit 131 removes the cluster C(k) of the head element from CL. Next, the processing advances to OP48.

In OP48, the execution history cluster generating unit 131 obtains a distance between a new cluster C(i)∪C(j) generated by the fusion in OP33 and the cluster C(k) of the head element of CL by the following formula.

d(C(i)∪C(j),C(k))=α(i)*d(C(i),C(k))+α(j)*d(C(j),C(k))+β*d(C(i),C(j))+γ|d(C(i),C(k))−d(C(j),C(k))| (Mathematical Expression 1)

The symbol “d” represents a distance between the cluster in (Mathematical Expression 1). For example, d(C(i),C(j)) represents a distance between the cluster C(i) and the cluster C(j). Further, α(i), α(j), β,γ are coefficients determined by a clustering technique. For instance, when using the nearest neighbor method and the median method, the coefficients take values given below.

Nearest Neighbor Method: α(i)=α(j)=½, β=0, γ=−½

Median Method: α(i)=α(j)=½, β=−¼, γ=0

Known additionally is a plurality of clustering methods being different in terms of determining the coefficients in (Mathematical Expression 1).

The distance obtained in (Mathematical Expression 1) is to be the degree of non-similarity between the cluster C(i) ∪C(j) and the cluster C(k). Next, the processing loops back to “c”, and the processes in OP45 through OP48 are repeated till the list of CL is emptied. The degree of non-similarity between the cluster C(i)∪C(j) and each of the clusters C(k) within the list being set in CL in OP43 through the processes illustrated in FIG. 11.

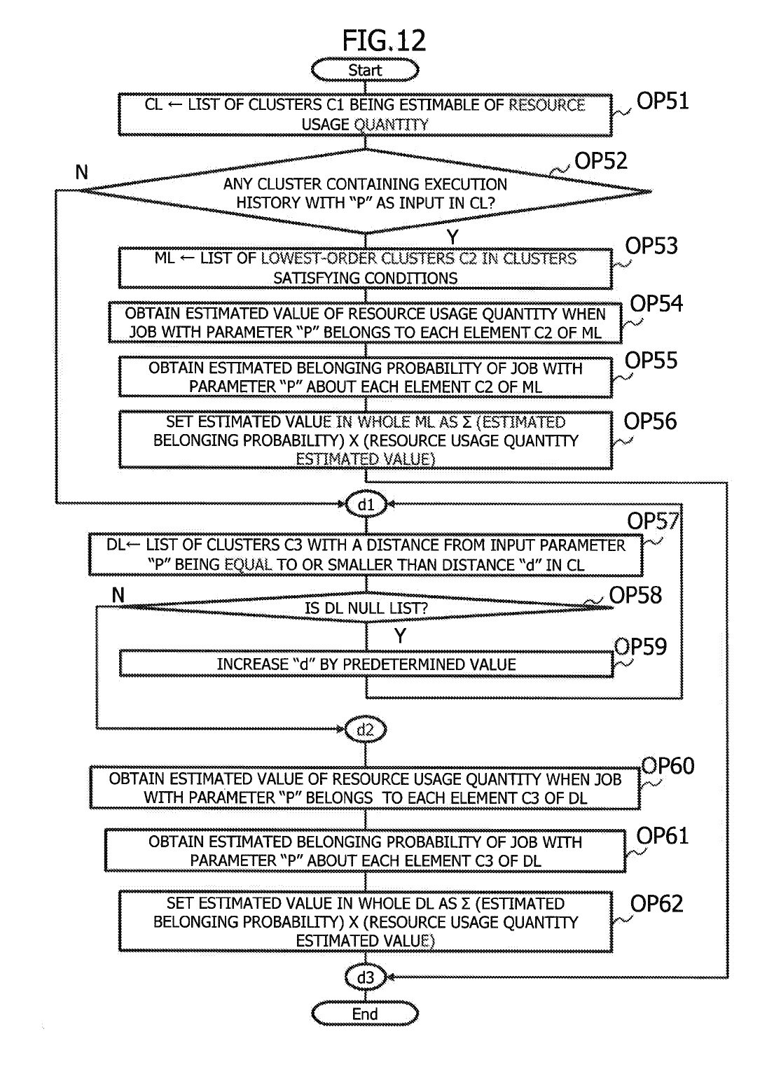

FIG. 12 is one example of a flowchart of a process of obtaining an estimated value of the resource usage quantity of the new job. When the new job belongs to the plurality of clusters, the resource usage quantity may be estimated corresponding to the belonging probability to each cluster. Furthermore, the resource usage quantity may be estimated from the execution history by the regression analysis with variables being the input parameter, the execution time, the appropriative resource and the resource usage variation within the cluster.

The regression analysis herein includes a multi-regression analysis based on a plurality of explanatory variables. For example, the multi-regression analysis is that the input parameter and the appropriative resource record list may be set as the explanatory variables, while each frequency component of a certain resource usage variation may be set as an objective variable. The multi-regression analysis is further that the input parameter may be set as the explanatory variable, while each frequency component of a certain resource usage variation may be set as the objective variable. However, one explanatory variable may also be available. For example, when the input parameter includes the execution scheduled time, the actual execution time can be explained by one parameter.

A start of the processes illustrated in FIG. 12 is triggered by, e.g., inputting the new job. In OP51, the new job belonging cluster presumption unit 132 sets, in CL, a list of clusters C1 from which the resource usage quantities can be estimated. The cluster C1, from which the resource usage quantity can be estimated, contains a predetermined number of execution histories and is a cluster from which the resource usage quantity can be estimated by the regression analysis and other equivalent analyses. Next, the processing advances to OP52.

In OP52, the new job belonging cluster presumption unit 132 determines whether or not the CL list includes the clusters containing the execution histories having the same input parameter as the input parameter P of the new job. When including the clusters containing the execution histories having the same input parameter (OP52: Y), the processing advances to OP53. Whereas when not including the clusters containing the execution histories having the same input parameter (OP52: N), the processing diverts to OP57.

In OP53, the new job belonging cluster presumption unit 132 sets, in ML, a list of lowest-order clusters C2 in the clusters satisfying a condition. The cluster satisfying the condition is a cluster containing the execution history having the same input parameter as the input parameter P of the new job. Next, the processing advances to OP54.

In OP54, the resource usage variation pattern presumption unit 133 obtains an estimated value of the resource usage quantity when the new job with the input parameter being “P” belongs thereto with respect to each element C2 of ML. Next, the processing advances to OP55.

In OP55, the resource usage variation pattern presumption unit 133 obtains an estimated belonging probability of the new job with the input parameter being “P” with respect to each element C2 of ML. Calculations are made as below under a condition that the input parameter or a combination of the input parameters is the same as “P” and on the assumption that a probability of the new job belonging to each cluster C2 is proportional to the number of execution histories with the input parameter being the same as “P” in each cluster C2.

N(C2)=(Number of Execution Histories with Input Parameter Being P)

N(ALL2)=(Total Number of Execution Histories with Input Parameter Being P)

Belonging Probability of Job with Input Parameter P for Cluster C2=N(C2)/N(ALL2)

Incidentally, with the ML element C2 being a single element, the belonging probability for one cluster thereof is assumed to be “1”. Next, the processing advances to OP56.

In OP56, the resource usage variation pattern presumption unit 133 sets the estimated value of the resource usage quantity in the whole ML as a total sum given by (Estimated Belonging Probability)×(Resource Usage Quantity Estimated Value) with respect to each cluster C2 of ML. Thereafter, the processing diverts to “d3”, and the processes illustrated in FIG. 12 are finished.

In OP57, the new job belonging cluster presumption unit 132 sets, in DL, a list of clusters C3 containing execution histories having the input parameter with a distance from the input parameter “P” of new job being equal to or smaller than a distance “d” in CL. The distance “d” may also be, e.g., the Euclidean distance with the respective components of the input parameter being weighted differently. Next, the processing advances to OP58.

In OP58, the new job belonging cluster presumption unit 132 determines whether DL is a null list or not. When DL is the null list (OP58: Y), the processing advances to OP59. Whereas when DL is not the null list (OP58: N), the processing diverts to OP60 (d2).

In OP59, the new job belonging cluster presumption unit 132 increases the distance “d” from the input parameter “P” of the new job by a predetermined value. The increased distance “d” leads to an expansion of a target range of the cluster with a distance from the input parameter “P” of the new job becoming equal to or smaller than “d”. Next, the processing loops back to “d1”, and the processes in OP57 through OP59 are repeated till the list is set in DL.

In OP60, the resource usage variation pattern presumption unit 133 obtains an estimated value of the resource usage quantity when the new job with the input parameter being “P” belongs thereto with respect to each element C3 of DL. Next, the processing advances to OP61.

In OP61, the resource usage variation pattern presumption unit 133 obtains an estimated belonging probability of the new job with the input parameter being “P” with respect to each element C3 of DL. Calculations are made as below on the assumption that a probability of the new job belonging to the cluster C3 is proportional to the number of execution histories with a distance from the input parameter “P” being equal to or smaller than “d” in the elements of the respective clusters C3.

N(C3)=(Number of Execution Histories with Distance from Input Parameter P Being Equal to or Smaller than d)

N(ALL3)=(Total Number of Execution Histories with Distance from Input Parameter P Being Equal to or Smaller than d)

Belonging Probability of Job with Input Parameter P for Cluster C32=N(C3)/N(ALL3)

Incidentally, with the DL element C3 being a single element, the belonging probability for one cluster thereof is assumed to be “1”. Next, the processing advances to OP62.

In OP62, the resource usage variation pattern presumption unit 133 sets the estimated value of the resource usage quantity in the whole DL as a total sum given by (Estimated Belonging Probability)×(Resource Usage Quantity Estimated Value) with respect to each cluster C3 of DL. Thereafter, the processing diverts to “d3”, and the processes illustrated in FIG. 12 are finished.

The appropriative resource specifying unit 134 specified, based on the estimated value of the resource usage quantity of the new job, an allocation position of the computing node 2 used for the new job.

<Operational Effect of First Embodiment>

The resource usage variation pattern presumption unit 133 may arbitrarily combine the conditions of the input parameter, the execution time, the appropriative resource, the resource usage variation and other equivalent conditions as the explanatory variables when estimating the resource usage variation by the regression analysis within the cluster. The resource usage variation pattern presumption unit 133 is thereby enabled to flexibly equalize the loads, corresponding to the focused resources.

The resource usage variation pattern presumption unit 133 may presume, when the plurality of clusters contains the execution histories of the jobs similar to the new job, a resource usage variation pattern of the new job by taking account of the belonging probability corresponding to the number of execution histories of the similar jobs contained in the respective clusters. The resource usage variation pattern presumption unit 133 is thereby enabled to estimate the resource usage quantity of the new job more accurately because of the resource usage quantity being estimated from a larger number of execution histories than the execution histories contained in the specified clusters.

The resource usage variation pattern presumption unit 133 extracts and compares the frequency component from the resource usage variation by the discrete Fourier transform, thereby determining the similarity of the resource usage variation pattern. The comparison of the frequency components enables the resource usage variation pattern presumption unit 133 to avoid overlooking, e.g., the similarity of substantially the same resource usage variation pattern that is moved in parallel by slightly shifting the time. With this contrivance, the resource usage variation pattern presumption unit 133 can more accurately estimate the resource usage quantity of the new job by specifying the proper similar jobs to the new job.

The new job belonging cluster presumption unit 132 can set the degree of non-similarity between the new job and the similar job as the Euclidean distance calculated from the values of the respective scales, the values being contained in the input parameters of the respective jobs. The new job belonging cluster presumption unit 132 is thereby enabled to presume the belonging cluster of the new job by deeming the job with the degree of non-similarity being smaller than a predetermined threshold value as the similar job even when there exists none of the similar job coincident with the new job in terms of the input parameter.

The new job belonging cluster presumption unit 132 may multiply each scale by a predetermined weighting coefficient when obtaining the Euclidean distance. With this contrivance, the new job belonging cluster presumption unit 132 can presume the similar job corresponding to the focused scale.

Through the operations described so far, the appropriative resource specifying unit 134 specifies the proper similar job to the new job, and more accurately estimates the resource usage quantity of the new job, thereby enabling an improvement of the equalization of the loads by optimizing the allocation of the computing node 2 to the new job.

### Second Embodiment

The parallel computer system according to a second embodiment optimizes the allocation position of the new job to reduce interference between the jobs on the basis of the resource usage quantity inclusive of the resource usage quantities of the existing jobs on the respective computing nodes 2. A description of the second embodiment will be made based on the assumption that the computing node 2 is a new job assigning target device, however, the new job assigning target device may also be a core when the CPU 2a is the multiprocessor and other equivalent processors each including a plurality of processor cores.

An apparatus configuration and a processing configuration in the second embodiment are the same as those in the first embodiment. The second embodiment omits the explanations overlapped with the first embodiment. The appropriative resource specifying unit 134 according to the second embodiment estimates a network resource usage quantity per time zone from each computing node 2 to each IO node 3, and optimizes the allocation position of the computing node 2 used for the new job to minimize a network congestion.

<Processing Flow>

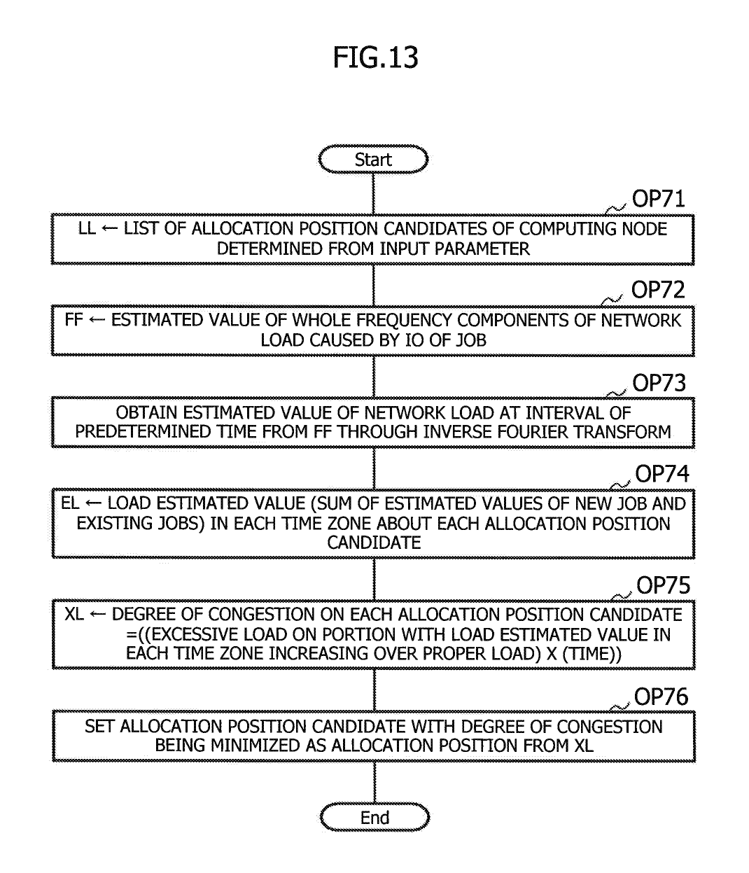

FIG. 13 is one example of a flowchart of a process of optimizing the allocation position of the resource used for the new job. The optimization of the allocation position is herein described as a process of equalizing the network load based on the resource usage quantity of the network. Processes illustrated in FIG. 13 are started after presuming the resource usage variation pattern in the processes depicted in FIG. 12.

In OP71, the appropriative resource specifying unit 134 sets, in LL, a list of allocation position candidates of the computing node 2 determined from the input parameter. The allocation position candidate is one computing node 2 or a combination of plural computing nodes 2. The list of allocation position candidates is acquired from the job scheduler node 1. Next, the processing advances to OP72.

In OP72, the appropriative resource specifying unit 134 sets, in FF, an estimated value of whole frequency components of the network load caused by the IO of the job. The network load corresponds to a resource usage quantity of the network. Further, the whole frequency components contain the frequency components of the network resource usage quantities with respect to the new job and the existing jobs. Next, the processing advances to OP73.

In OP73, the appropriative resource specifying unit 134 obtains an estimated value of the network load at an interval of predetermined time from FF by inverse Fourier transform. Next, the processing advances to OP74. In OP74, the appropriative resource specifying unit 134 sets, in EL, a load estimated value in each time zone about each allocation position candidate. The load estimated value is obtained per computing node 2 included in the allocation position candidates. Moreover, the load estimated value is a sum of the load estimated values of the new job and the existing jobs. Next, the processing advances to OP75.

In OP75, the appropriative resource specifying unit 134 sets, in XL, a degree of congestion on each allocation position candidate. The degree of congestion on each allocation position candidate is a sum of ((Excessive Load on Portion with Load Estimated Value in Each Time Zone Increasing over Proper Load)×(Time)). Next, the processing advances to OP76.

In OP76, the appropriative resource specifying unit 134 sets the allocation position candidate with the degree of congestion being minimized as the allocation position from XL. The processes illustrated in FIG. 13 are thereafter finished.

<Operational Effect of Second Embodiment>

The IO node group is separated from the computing node group and becomes a shared resource that is to be accessed from the computing node group via the network in a parallel computer environment. It is therefore requested to reduce the interference between IO loads by equalizing the IO loads inclusive of the network load.

The appropriative resource specifying unit 134 according to the second embodiment estimates the network resource usage quantities of the new job and the existing jobs, and assigns the new job to the allocation position candidate to equalize the resource usage quantity in each time zone with respect to each appropriative resource. With this job assignment, the parallel computer system 10 can equalize the IO load to take the network into consideration, and can reduce the interference with the existing job.

The resource to be taken into consideration for equalizing the load and reducing the interference is not limited to the network resource. The allocation position may also be optimized by estimating the resource usage quantity on the basis of other resources or a combination of the plurality of resources including the network resource. The parallel computer system can equalize the load and reduce the interference, corresponding to the resource taken into consideration or the combination of the resources taken into consideration.

The parallel computer system, the management apparatus, the control method for the parallel computer system and the control program of the management apparatus of the disclosure, can improve the equalization of the loads on the plurality of information apparatuses to execute the jobs.

### <Non-Transitory Recording Medium>

A program for making a computer, other machines and apparatuses (which will hereinafter be referred to as the computer and other equivalent apparatuses) attain any one of the functions, can be recorded on a non-transitory recording medium readable by the computer and other equivalent apparatuses. Then, the computer and other equivalent apparatuses are made to read and execute the program on this non-transitory recording medium, whereby the function thereof can be provided.

Herein, the non-transitory recording medium readable by the computer and other equivalent apparatuses connotes a non-transitory recording medium capable of accumulating information instanced by data, programs and other equivalent information electrically, magnetically, optically, mechanically or by chemical action, which can be read from the computer and other equivalent apparatuses. Among these non-transitory recording mediums, the mediums removable from the computer and other equivalent apparatuses are exemplified by a flexible disc, a magneto-optic disc, a CD-ROM, a CD-R/W, a DVD, a Blu-ray disc, a DAT, an 8 mm tape, and a memory card like a flash memory. Further, a hard disc, a ROM (Read-Only Memory) and other equivalent recording mediums are given as the non-transitory recording mediums fixed within the computer and other equivalent apparatuses. Still further, a solid state drive (SSD) is also available as the non-transitory recording medium removable from the computer and other equivalent apparatuses and also as the non-transitory recording medium fixed within the computer and other equivalent apparatuses.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A parallel computer system comprising:
a plurality of information processing apparatuses; and
a management apparatus to control the plurality of information processing apparatuses,
wherein each of the plurality of information processing apparatuses includes a processor, and a memory storing instructions, the instructions causing the processor to perform:
outputting a resource usage quantity variation per resource of a self-apparatus with respect to a job to be executed by the self-apparatus at a predetermined time interval, and
the management apparatus includes a processor, and a memory storing instructions, the instructions causing the processor to perform:
generating an execution history containing an attribute of the execution target job and the resource usage quantity variation being output by the processor of each information processing apparatus every time the job is executed;
estimating a resource usage quantity of a new job being newly inputted, based on resource usage quantity variations contained in an execution history of a reference job matching the new job in terms of the attribute within a predetermined degree; and
specifying the information processing apparatus to be assigned the new job, based on the estimated resource usage quantity.

2. The parallel computer system according to claim 1,
wherein the processor of the management apparatus further performs:
classifying the generated execution histories into a plurality of groups, based on predetermined degrees of matching about the attribute and the resource usage quantity variation, and
estimating the resource usage quantity variation of the group containing the execution histories of the reference jobs based on a regression analysis, and the resource usage quantity of the new job based on the estimated resource usage quantity variation.

3. The parallel computer system according to claim 1, wherein the processor of the management apparatus calculates a belonging probability to each group, based on a number of execution histories, contained in the respective groups, of the reference jobs when there exists a plurality of groups containing the execution histories of the reference jobs, and estimates the resource usage quantity of the new job, based on the resource usage quantity variation and the belonging probability of each group.

4. The parallel computer system according to claim 1, wherein the execution history contains frequency components as the resource usage quantity variation.

5. The parallel computer system according to claim 1, wherein the reference job is a job with a Euclidean distance being smaller than a predetermined threshold value, the Euclidean distance being calculated by use of attribute values of the attributes of the reference job and attribute values of the attributes of the new job as components.

6. The parallel computer system according to claim 5, wherein the Euclidean distance is obtained by multiplication of a weighting coefficient being different per component.

7. The parallel computer system according to claim 1, wherein the processor of the management apparatus specifies, from within a plurality of combinations of one or more information processing apparatuses selected from the plurality of information processing apparatuses, a combination in which a sum of estimated values of resource usage quantities of the new job and the existing jobs on each information processing apparatus in the combination is smaller than that in other combination as the combination of one or more information processing apparatuses to be assigned to the new job.

8. The parallel computer system according to claim 1, wherein the plurality of information processing apparatuses includes computing nodes to execute processes of the jobs and input/output nodes to execute input/output processing for the jobs, and
a usage quantity of a network resource between the computing node and the input/output node is contained as one of the resource usage quantities.

9. A control method for a parallel computer system comprising: a plurality of information processing apparatuses; and a management apparatus to control the plurality of information processing apparatuses, the control method comprising:
outputting a resource usage quantity variation per resource of a self-apparatus with respect to a job to be executed by the self-apparatus at a predetermined time interval by a processor of each of the plurality of information processing apparatuses,
generating an execution history containing an attribute of the execution target job and the resource usage quantity variation being output by each information processing apparatus every time the job is executed by a processor of the management apparatus;
estimating a resource usage quantity of a new job being newly inputted, based on resource usage quantity variations contained in an execution history of a reference job matching the new job in terms of the attribute within a predetermined degree by the processor of the management apparatus; and
specifying the information processing apparatus to be assigned the new job, based on the estimated resource usage quantity by the processor of the management apparatus.

10. A management apparatus to control a plurality of information processing apparatuses, the management apparatus comprising
a processor, and
a memory storing instructions, the instructions causing the processor to perform:
generating an execution history containing an attribute of the execution target job and the resource usage quantity variation being output by each information processing apparatus per execution of the job to be executed by each of the plurality of information processing apparatuses;
estimating a resource usage quantity of a new job being newly inputted, based on resource usage quantity variations contained in an execution history of a reference job matching the new job in terms of the attribute within a predetermined degree; and
specifying the information processing apparatus to be assigned the new job, based on the estimated resource usage quantity.

11. A computer-readable recording medium having stored therein a program for causing a computer to execute a process for controlling a management apparatus, the process comprising:
generating, by the processor of the management apparatus, an execution history containing an attribute of an execution target job and a resource usage quantity variation being output by each information processing apparatus per execution of the job to be executed by each of the plurality of information processing apparatuses;
estimating, by the processor of the management apparatus, a resource usage quantity of a new job being newly inputted, based on resource usage quantity variations contained in an execution history of a reference job matching the new job in terms of the attribute within a predetermined degree; and
specifying, by the processor of the management apparatus, the information processing apparatus to be assigned the new job, based on the estimated resource usage quantity.
